(19) United States
(12) Patent Application Publication
(10) Pub. No.: US 2026/0051422 A1
(43) Pub. Date: Feb. 19, 2026

(54) subsea cable wherein parts of its length constitute the use of a conductor with insulated wires

(71) Applicant: NEXANS, Courbevoie (FR)

(72) Inventors: Audun Johanson, Oslo (NO); Jason Allen, Goose Creek, SC (US)

(21) Appl. No.: 19/297,296

(22) Filed: Aug. 12, 2025

Related U.S. Application Data
(60) Provisional application No. 63/682,956, filed on Aug. 14, 2024.

(30) Foreign Application Priority Data
Aug. 30, 2024 (NO) 20240885

(51) Int. Cl. H01B 7/285; H01B 1/02; H01B 3/08; H01B 7/00; H01B 13/00; H01B 13/06; H01B 13/32

(52) U.S. Cl. CPC H01B 7/285; H01B 3/081; H01B 7/0081; H01B 13/0016; H01B 13/065; H01B 13/322; H01B 1/026

(57) ABSTRACT

The present invention relates to the technical field of subsea power cables. More specifically, the invention relates to a subsea power cable comprising at least one cable core, the cable core comprising a metal conductor, the metal conductor comprising at least one metal wire, wherein a section of the at least one metal wire along the longitudinal direction is surrounded with a material of low electrical conductivity.

### CROSS REFERENCE TO RELATED APPLICATIONS

This application is related to and claims the benefit of U.S. Provisional Patent Application No. 63/682,956 filed 14 Aug. 2024 and Norwegian Patent Application Number 20240885 filed 14 Aug. 2024, where the entire contents of both of said applications are incorporated herein by reference.

### FIELD OF THE INVENTION

The present invention relates to the technical field of subsea power cables. More specifically, the invention relates to a subsea power cable comprising at least one cable core, the cable core comprising a metal conductor, the metal conductor comprising at least one metal wire, wherein a section of the at least one metal wire along the longitudinal direction is surrounded with a material with low electrical conductivity.

### BACKGROUND

There is a general need for subsea power cables to deliver electric power via distances spanning the sea. For such purposes, subsea cables are developed which distinguish significantly from land cables. One issue in view of subsea cables refers to increasing energy quantities conducted through the subsea power cables. The increase in energy quantity is accomplished either via larger cross-sections of the electrical conductor or increased voltage. The higher voltages require increased insulator thickness.

The increased diameter of the power cables associated with increased energy quantity and increased voltages has an impact on the mechanical properties and requirements of the power cable. Especially if the power cables are also exposed to mechanical loads imposed during dynamic movements of the cable from the method of installing it or from wave motions and subsea currents after having installed the power cable, the mechanical properties and requirements play a crucial role. Consequently, the goal of increasing energy quantities and voltages conflicts with safe mechanical issues, in particular with fatigue of the outer parts of the subsea cables such as the water barrier sheath. The reduction of the conductor cross-section while maintaining the ampacity is of paramount relevance for dynamic high voltage subsea power cables. This problem becomes of particular interest in case of thermal hot-spots or in landfall section.

A problem solved by the invention relates to the provision of a subsea power cable and a method of its manufacturing, which subsea power cable provides increased transmission of power quantity per area cross-section. A further problem solved by the invention relates to the provision of a subsea power cable and a method of its manufacturing, which subsea power cable provides improved insulation properties of the insulation system of the power cable. In particular, a problem solved by the invention relates to improvements of the power cable's properties in terms of heat development in the power cable, especially at accessories for the power cable.

### SUMMARY OF THE INVENTION

The invention's underlying problems are solved by the subject-matter of claim 1. A first aspect of the invention therefore relates to a power cable for subsea applications, the power cable comprising at least one cable core, the cable core comprising a metal conductor, the metal conductor comprising at least one metal wire, wherein a section of the at least one metal wire along the longitudinal direction is surrounded with a material having an electrical conductivity of less than 1×10⁻⁸ S/m at 20° C.

The power cable is a subsea power cable. A skilled person will immediately anticipate that subsea power cables distinguish in structure and properties from land cables. Land cables can be provided with a broader variety of isolation materials as they do not have to withstand severe mechanical dynamics and impact from subsea use. Structural features common for land cables are thus not immediately transferred to subsea power cables.

According to the invention, the at least one metal wire, e.g. the at least one copper wire, as the conductor is replaced by a metal wire covered with an insulation material, in particular enamel. In the following, the material having an electrical conductivity of less than 1×10⁻⁸ S/m at 20° C., preferably less than 1×10⁻¹⁴ S/m at 20° C., more preferred 1×10⁻¹⁶ S/m at 20° C., most preferred less than 1×10⁻¹⁸ S/m at 20° C., is designated as insulation material.

The provision of this insulation material enhances the effective conductor cross-section by suppressing AC skin effect. As for the skin effect, the term is understood by a skilled person: In electromagnetism, skin effect is the tendency of an alternating electric current (AC) to become distributed within a conductor such that the current density is largest near the surface of the conductor and decreases exponentially with greater depths in the conductor. It is caused by opposing eddy currents induced by the changing magnetic field resulting from the alternating current. The electric current flows mainly at the skin of the conductor, between the outer surface and a level called the skin depth. This shall be done for thermal hot-spots or other sections, in particular the length passing through the bend-stiffener in dynamic cables where it is of particular interest to locally reduce the conductor cross-section to alleviate fatigue damage on the water barrier sheath located radially outwards to the conductor. This will typically allow for one size reduction of a standard conductor cross-section while maintaining the same ampacity.

According to the invention, the metal conductor is surrounded by a material defined by its electrical conductivity, i.e. the insulation material. The term “electrical conductivity” (or specific conductance) is understood as a person skilled in the art understands it, as e.g. described in Wikipedia: The electrical conductivity is reciprocal of electrical resistivity, it represents a material's ability to conduct electric current. The SI unit of electrical conductivity is Siemens per meter (S/m). Resistivity and conductivity are intensive properties of materials, giving the opposition of a standard cube of material to current. Electrical resistance and conductance are corresponding extensive properties that give the opposition of a specific object to electric current. Since the electrical conductivity is reciprocal of electrical resistivity, the quantity can easily be measured. A person skilled in the art will easily find a material fulfilling these requirements. There is thus no undue burden on finding materials fulfilling the requirements.

In one aspect, the material may have an electrical conductivity of less than 1×10⁻¹⁴ S/m at 20° C., preferably 1×10⁻¹⁶ S/m at 20° C., more preferred less than 1×10⁻¹⁸ S/m at 20° C.

In one aspect, the material having the electrical conductivity of less than 1×10⁻⁸ S/m at 20° C. may be a fused inorganic material, more preferred an amorphous fused inorganic material.

In one aspect, the material having the electrical conductivity of less than 1×10⁻⁸ S/m at 20° C. may be enamel, preferably vitreous enamel. The power cable may be a subsea power cable, wherein the power cable comprises at least one cable core, the cable core comprising a metal conductor, the metal conductor comprising at least one metal wire, wherein a section of the at least one metal wire along the longitudinal direction is surrounded by a fused inorganic material, preferably by enamel, more preferred vitreous enamel. The insulation material may be a fused inorganic material, preferably enamel, more preferred vitreous enamel. In line with the present invention, the term “surrounding” means radially surrounded, i.e. that the metal wire is fully surrounded by the insulation material.

The terms “enamel” and “vitreous enamel” are understood by the skilled person. It is a material made by fusing powdered glass to a substrate by firing, usually between 750 and 850° C. It is thus a silicon oxide based material being characterized in having no long range crystallinity on an atomic level. In other words, it could be described as frozen liquid.

The term “longitudinal direction” refers to the direction of the length of the power cable. This is not necessarily the direction of the metal wire as the metal wire can be helically turned relative to the longitudinal direction of the cable.

In one aspect, at least 20%, 30%, 50%, or 75% of the power cable may be surrounded by the inorganic material in the longitudinal direction of the power cable. In a further aspect, each of the metal wires may be surrounded by the inorganic material or a part of the metal wires is surrounded by the inorganic material. The inorganic material may be identical or different for each wire.

In one aspect, the power cable may be a dynamic power cable. In particular, the subsea power cable may be a dynamic subsea power cable. In general, dynamic cables are associated with a high fatigue endurance. They are designed to withstand a lifetime of constant movement. For that reason, dynamic power cables must be much more durable and flexible than static power cables. It was believed that enamel surrounded conductors are exposed to mechanical stress such that the enamel breaks. However, it has been found that the enamel surrounding each conductor withstands the stress exposed to dynamic power cables. In one aspect, the dynamic power cable is provided with the insulation material.

In one embodiment, the section may have a length shorter than the complete length of the power cable. It may be beneficial to have sections along the longitudinal direction of the power cable, where the conductor is not provided with the insulation material surrounding the conductor, as e.g. parts of the power cable where joints are foreseen. In a further embodiment, the section may be limited to the dynamic section suspended between the floating structure. In a further embodiment, the section may be limited to the section at the upper end of the dynamic section. The upper section may be protected by a bend stiffener covering a length of 0.5 to 15 m. This embodiment is e.g. beneficial in regions where bend-stiffeners are used. In other words, the deposition of enamel may be done only for the length passing through the bend-stiffener. The particular lengths of the bend stiffeners may vary.

In one embodiment, the invention may refer to the use of the subsea power cable in combination with a bend-stiffener. Therefore, according to one aspect, the power cable may be provided with a bend stiffener. A bend stiffener is well known in the art. In the framework of this invention, the bend stiffener as well as other power cable's accessories as described herein are by definition part of the power cable. If the bend stiffener is used as gadget separate from the power cable, it becomes part of the power cable as soon as it functions as bend stiffener for the power cable.

The insulation material is preferably provided on the surface of the metal wire at position where the bend stiffener is provided or in its vicinity because the insulation material suppresses the skin effect which suppression has a beneficial effect on heat development which should especially be avoided at the bend stiffener.

In one aspect, the power cable may be provided with the bend stiffener at an end segment of the power cable or at a cable joint. In this aspect, the bend stiffener works as a mechanical protection at a position where the power cable arrives at the cable termination respectively where two cables join each other and being connected to one another. If the bend stiffener is arranged at the end segment of the power cable, the power cable is a dynamic power cable.

In one aspect, the bend stiffener preferably has a position L along the longitudinal direction of the power cable, which L is as well the length of the bend stiffener along the longitudinal direction of the power cable, wherein the section of the at least one metal wire being surrounded with the insulation material is at least partly arranged at the position L. The term “position” when describing the arrangement of the bend stiffener, the insulation material or the elastomeric material refers to the longitudinal direction of the power cable irrespective of whether it is inside the power cable/cable core or at the outside of the power cable/cable core.

According to this aspect, the bend stiffener has an extension along the longitudinal direction. The length L designates the position of the bend stiffener, i.e. all points on the surface of the power cable where the bend stiffener is placed form the position L. The measured extension of the bend stiffener is designated L as well. It might be the case that a fixation gadget of the end segment of the power cable is part of the bend stiffener. Alternatively, the bend stiffener can be distinguished from other accessories of the power cable such that the bend stiffener having a starting point and an end point resulting in a length L between these points. This aspect defines that the insulation material is at least partly arranged on the metal surface of the metal wire where the bend stiffener is arranged on the outer layer of the power cable. When following the longitudinal direction of the power cable in the direction of the midpoint of the power cable, it might be that a point of the power cable is provided with the bend stiffener on the outermost layer of the power cable, however not provided with the insulation material on the metal wire. When further following the longitudinal direction of the power cable in the direction of the midpoint of the power cable, points of the power cable follow where both the bend stiffener and the insulation material are provided.

In one aspect, the section of the at least one metal wire being surrounded with the insulation material may extend beyond the position along the longitudinal direction of the cable being provided with the bend stiffener. According to this aspect, there are positions of the power cable being provided with the bend stiffener on the outermost layer of the power cable and with the insulation material, wherein the section provided with the insulation material extends to positions of the power cable where the outermost surface of the power cable is not provided with the bend stiffener.

In one aspect, a length of the section of the at least one metal wire being surrounded with the insulation material, wherein the length is measured along the longitudinal direction of the power cable, may exceed the length L by a factor of 1.05 to 50, preferably 2 to 20, more preferred 5 to 10, provided that the section of the at least one metal wire being surrounded with the insulation material at least partially overlaps with the length L. According to this aspect, the insulation material is provided on the surface of the metal wire in the section having a measurable length which exceeds the length L of the bend stiffener by the factor of 1.05 to 3. In this aspect, it is demanded that there are positions where the bend stiffener is arranged on the outermost layer of the power cable and at the same position the insulation material is arranged. This ensures that the heat development is avoided at the position L and adjacent thereto.

In a further alternative aspect, the ratio of the length L to the total length of the power cable is in the range of 0.005 to 1, preferably 0.05 to less than 1, more preferred to 0.1 to 0.5.

In one aspect, the power cable may be characterized by having sections along the longitudinal direction where the electrical conductor is provided with the insulation material and other sections where the electrical conductor is devoid of the insulation material. Preferably, from 80% to less than 100% of the power cable, more preferred 85% to 95% of the power cable, may consist of sections where the electrical conductor is surrounded by enamel. This aspect represents an alternative to the aspect where the power cable is provided with the insulation material only at a position where a bend-stiffener or joint is arranged respectively adjacent to said positions.

In one aspect, the at least one wire may comprise aluminum or an aluminum alloy, or copper or a copper alloy, preferably copper or a copper alloy.

In one aspect, the metal conductor may comprise more than one metal wire and each metal wire is surrounded by an elastomeric material in a segment. According to this aspect, the cable core comprises more than one metal wire, wherein the voids between the more than one metal wire are filled with the elastomeric material.

The provision of the elastomeric material may limit the water ingress or render the cable core watertight in longitudinal direction. Subsea power cables may suffer from water entering the conductor in case of breakage in one or more cable layers. It is then critical to limit longitudinal water penetration in the longitudinal direction of the conductor (in between individual wires or layers). It is a well-known problem that water inside the cable core flows in a longitudinal direction along the cable core where it may cause corrosion. The elastomeric material may limit or prevent water from flowing in longitudinal direction within the cable core. The elastomeric material could be seen by its nature to be an insulating layer. However, as will be understood by a skilled person, the elastomeric material distinguishes from the insulation material.

In one aspect, the elastomeric material in the segment may be solely attached to the surface of the metal wire. According to this aspect, the elastomeric material is not present in the cable at positions where the metal wires are covered with the insulation material.

In a preferred aspect, the elastomeric material is provided in static cable sections.

In an alternative aspect, the segment of the elastomeric material may at least partially overlap in longitudinal direction of the power cable with the section of the at least one metal wire being surrounded with the insulation material. According to this aspect, at least a part of the elastomeric material is attached to the surface of the metal wire and also at least a part of the elastomeric material is attached to the surface of the insulation material.

In an alternative aspect, the cable core may comprise the metal conductor surrounded by enamel, which enamel is surrounded by the elastomeric material. The provision of the metal conductor with enamel is associated with the above described beneficial effects.

In one aspect, the elastomeric material may be an elastomeric thermoset material. In the framework of this invention, a “thermoset material” is understood as a material being subjected to an irreversible hardening.

In one aspect, the power cable may comprise section transitions to a power cable with one or more conductors, with one or more wires that is not provided with a fused inorganic material.

In one aspect, the metal conductor may comprise more than one metal wire being devoid of distinguishable bundles of the more than one metal wire. According to this aspect, the cable core of the power cable may not have the structure of bundles of metal wires wherein more than one bundle is part of the cable core. Such bundles are often stranded by individual metal wires first, wherein the stranded metal wires forming the bundle are then arranged to form part of the cable core. Such a cable core structure is typical for land cables or static cables in general. According to this aspect of the present invention, the cable core may be devoid of such multiple distinguishable bundles of metal wires. It is to be understood that the cable may nevertheless be constructed by multiple cable cores. As well, the power cable could be an AC power cable having more than one stranded metal wire. The multiple distinguishable bundles of metal wires may according to this preferred aspect not be put into practice within one surrounding isolator.

In one aspect, the power cable may be a high voltage cable, preferably adapted to be used for voltages from 123 kV to 3,000 kV, preferably from 250 to 1,300 kV, more preferred from 500 to 1,100 kV.

In one aspect, the ampacity versus cross-section of the metal conductor may amount to 1 A/mm² to 200 A/mm², preferably 2 A/mm² to 100 A/mm², more preferred 5 A/mm² to 50 A/mm².

The feature ampacity versus cross-section, which could alternatively be designated as ampacity per area of the cross-section, is the feature being ameliorated by the invention, i.e. by the deposition of enamel onto the metal wire, this feature can be increased compared to power cables where the enamel is not deposited.

In one aspect, the metal conductor may have a diameter of 10 mm to 90 mm, preferably more than 10 mm to less than 90 mm, more preferred from 25 mm to 70 mm, even more preferred 40 to 60 mm, most preferred 42 to 58 mm.

The diameter of the metal conductor may be measured as the largest cross section of the metal conductor. Power cables having a smaller diameter do not benefit from invention to such an extent as power cables do, which may have a diameter in line with the preferred embodiment.

The invention's underlying problems are further solved by the subject-matter of claim 14. A second aspect of the invention therefore relates to a method of manufacturing a power cable comprising the following steps: providing at least one metal wire and a precursor of a fused inorganic material; depositing the precursor of the fused inorganic material onto the at least one metal wire; heating the precursor of the fused inorganic material to obtain the fused inorganic material on the at least one metal wire.

The method according to the invention produces a metal wire surrounded by an insulation material, i.e. a material having low electrical conductivity at room temperature. The substance applied to the wire is the precursor of a fused inorganic material.

In one aspect, the method may comprise the steps of arranging more than one of the at least one metal wire with the fused inorganic material to obtain one stranded metal conductor; and introducing an elastomeric material into voids between the more than one metal wires of the stranded metal conductor.

According to this aspect, a power cable may be provided which comprises a water blocking material in the cable core of the finished product of the power cable. In one aspect, in the method of the above aspect, the step of introducing the elastomeric material into the voids of the stranded metal conductor may be interrupted such that the stranded metal conductor comprises at least one segment along the longitudinal direction of the power cable where the stranded metal conductor is provided with the elastomeric materials and at least one further segment along the longitudinal direction of the power cable where the stranded metal conductor is devoid of the elastomeric material. In other words, the elastomeric material may fill the voids of the stranded metal conductor in at least one segment along the longitudinal direction of the power cable to block longitudinal water ingress.

In one aspect, there may be a continuous filling of the voids with the elastomeric material.

A skilled person will understand that power cables have a water barrier sheath preventing water from entering into inner parts of the power cable. The water blocking material in the sense of this application may be a barrier preventing water from flowing inside the cable in longitudinal direction.

According to this aspect, a power cable can be obtained having segments with elastomeric material and segments being devoid of elastomeric material. In case water enters the cable core, the elastomeric material prevents the water from flowing in longitudinal direction of the cable core. A skilled person will understand that the term “segment” distinguishes from “section” and both distinguish from the term “end segment”. The section of the power cable refers to the parts of the power cable with or without enamel deposited on the metal wire. The segment of the power cable refers to the parts of the power cable with or without the elastomeric material on the enamel respectively the metal wire. According to a preferred embodiment of the invention, it is possible that the parts of the metal wire being devoid of enamel are provided with the elastomeric material or are not provided with the enamel.

In one aspect, the method may further comprise one or more of the following steps: surrounding the at least one metal wires by an insulating layer; surrounding the insulating layer (8) by a semiconductor layer; providing an armouring layer.

Features being solely disclosed in connection with the device of the invention are deemed to be disclosed in connection with the methods or the use of the invention and vice versa.

### BRIEF DESCRIPTION OF THE DRAWINGS

Certain aspects of the presently disclosed subject-matter will be described with reference to the accompanying drawings, which are representative and schematic in nature and are not considered to be limiting in any respect as it relates to the scope of the subject-matter disclosed herein:

FIG. 1 Depicts a Cross-section of the Cable Core of the Power Cable;

FIG. 2 depicts a longitudinal cross-section of the cable core; and

FIG. 3 depicts a cross-section of a power cable provided with a bend stiffener

### DESCRIPTION OF EMBODIMENTS

The Figures show exemplary embodiments of the invention solely schematically. The Figures intend to show the parts of the cable core or parts of the power cable not drawn to scale.

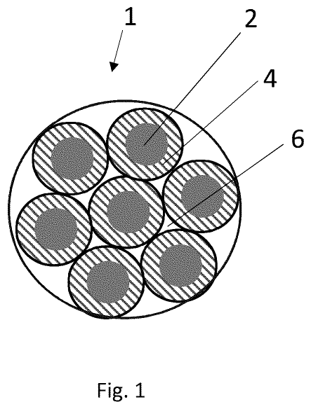

FIG. 1 shows a schematic drawing of a power cable displaying exemplary a cable core 1 comprising seven metal wires 2 surrounded by the material 4 having low electrical conductivity. According to a preferred embodiment, the material is enamel 4. Between the stranded metal wires 2, there are voids 6, which may be filled with an elastomeric material 5 (not shown in FIG. 1).

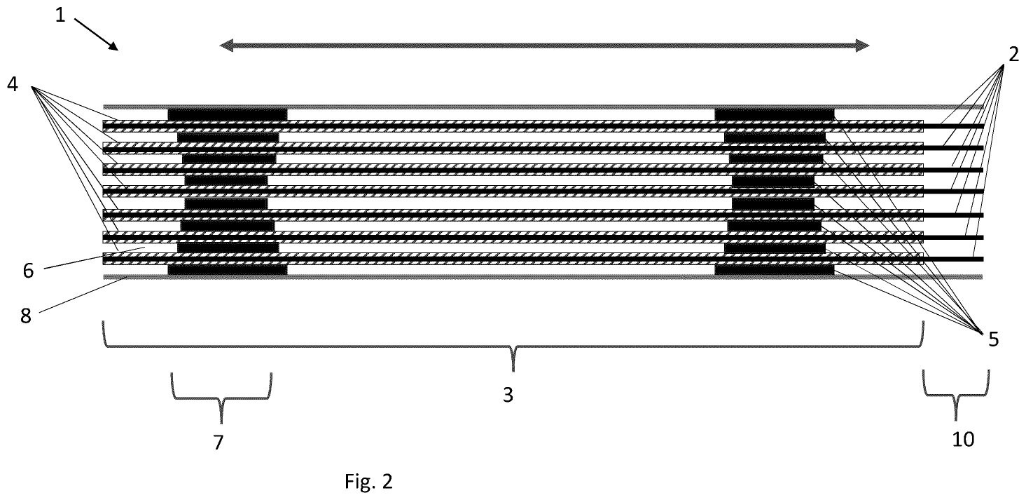

FIG. 2 shows a cross-section of a cable core 1, which cross-section is shown in longitudinal direction. The longitudinal direction is indicated by the double arrow in FIG. 2. The power cable (not shown in its entirety) comprises the cable core 1. The cable core 1 comprises metal wires 2, which are shown in FIG. 2 in a parallel fashion. In practice, the metal wires 2 are stranded such that they are not parallel to one another. The metal wires 2 are surrounded by an insulation material 4 having low electrical conductivity. The insulation material, preferably enamel 4, is deposited on the metal wire 2 in a section 3 which section 3 is smaller than the total length of the power cable. As a consequence, the cable core has a section 10 of the cable core being devoid of the insulation material 4.

The voids 6 may be filled with an elastomeric material 5. The elastomeric material 5 is preferably filled in segments 7 along the longitudinal direction of the power cable. Such structure is obtained in that the introduction of elastomeric material is interrupted when stranding the metal wires 2 in the method of manufacturing the power cable. The cable core 1 is surrounded by a layer of an insulating material 8. The cable core 1 is also surrounded by a semiconductive material.

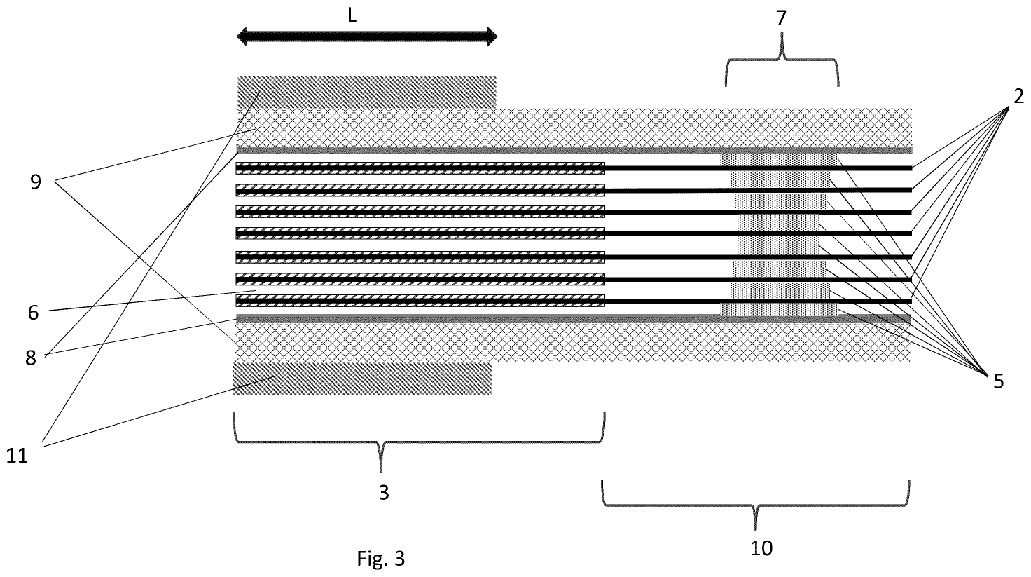

FIG. 3 shows a power cable with a cable core schematically shown in FIG. 2, wherein the power cable comprises further cable layers 9 attached to the layer of an insulating material 8 which further cable layers 9 are not further specified herein. The power cable is provided with a bend stiffener 11 attached to the outermost layer of the power cable. In segment 7, the elastomeric material 5 is filled in the voids 6 of the cable core 1. The elastomeric material 5 is directly attached to the surface of the metal wires 2.

In section 3, the metal wires 2 are surrounded by the insulation material 4 having low electrical conductivity, in particular the enamel. It is shown that the bend stiffener 11 is attached to the outermost layer of the power cable only in an end segment of the power cable. In this end segment and extending further in longitudinal direction of the power cable, the metal wires 2 are provided with the insulation material 4 having low electrical conductivity, in particular the enamel. This arrangement is associated with the beneficial effect that the heat generation in this longitudinal part of the power cable is reduced. The end segment provided with the bend stiffener 11 can be subjected to a heat development which is associated with technical drawbacks. The provision of the insulation material 4 having low electrical conductivity surrounding the metal wires 2 at the longitudinal position of the bend stiffener 11 suppresses the heat development. It is especially beneficial if the insulation material 4 having low electrical conductivity surrounding the metal wires 2 is extended beyond the end segment. This situation is shown in FIG. 3, where section 3 extends beyond the end segment where the bend stiffener 11 is provided.

In one embodiment, it is possible that segment 7 overlaps with the section 3 of the at least one metal wire 2 being surrounded with the insulation material 4. Thus, in one embodiment, a part of the elastomeric material serving as water blocking compound is attached to the metal surface of the metal wire 2 and a further part of the elastomeric material is attached to the insulation material 4.

The following items are disclosed showing particular embodiments of the application:
1. A power cable for subsea applications,
   the power cable comprising at least one cable core (1),
   the cable core (1) comprising a metal conductor,
   the metal conductor comprising at least one metal wire (2),
   wherein at least a section (3) of the at least one metal wire (2) along the longitudinal direction is surrounded with a material (4) having an electrical conductivity of less than 1×10⁻⁸ S/m at 20° C.
2. The power cable according to item 1, wherein the material (4) has an electrical conductivity of less than 1×10⁻¹⁴ S/m at 20° C., preferably 1×10⁻¹⁶ S/m at 20° C., more preferred less than 1×10⁻¹⁸ S/m at 20° C.
3. The power cable according to item 1 or item 2, wherein the material (4) having the electrical conductivity of less than 1×10⁻⁸ S/m at 20° C. is a fused inorganic material.
4. The power cable according to item 3, wherein the fused inorganic material is an amorphous fused inorganic material (4).
5. The power cable according to item 4, wherein the amorphous fused inorganic material is enamel (4), preferably vitreous enamel.
6. The power cable according to any one of the preceding items, wherein the section (3) has a length shorter than the complete length of the power cable.
7. The power cable according to any one of the preceding items, wherein the at least one metal wire (2) comprises copper or a copper alloy.
8. The power cable according to any one of the preceding items, wherein the metal conductor comprises more than one metal wire (2) and each metal wire is surrounded by an elastomeric material (5) used as water blocking material, preferably wherein the elastomeric material (5) is in contact with the fused inorganic material (4).
9. The power cable according to any one of the preceding items, wherein the elastomeric material (5) is an elastomeric thermoset material.
10. The power cable according to any one of the preceding items, wherein the power cable is a dynamic power cable.
11. The power cable according to any more of the preceding items, wherein section transitions to a power cable with one or more conductors, with one or more wires that is not provided with a fused inorganic material (4).
12. The power cable according to any one of the preceding items, wherein the metal conductor comprises more than one metal wire (2) being devoid of distinguishable bundles of the more than one metal wire.
13. The power cable according to any one of the preceding vs, wherein the power cable is a high voltage cable, preferably adapted to be used for voltages from 123 kV to 3,000 kV.
14. The power cable according to any one of the preceding items, wherein the ampacity versus cross-section of the metal conductor amounts to 1 A/mm² to 200 A/mm², preferably 2 A/mm² to 100 A/mm², more preferred 5 A/mm² to 50 A/mm².
15. A method of manufacturing a power cable comprising the following steps:
   providing at least one metal wire (2) and a precursor of a fused inorganic material;
   depositing the precursor of the fused inorganic material (4) onto the at least one metal wire (2);
   heating the precursor of the fused inorganic material (4) to obtain the fused inorganic material on the at least one metal wire (2).
16. the Method According to Item 15, wherein the method comprises the step of
   arranging more than one of the at least one metal wire (2) with the fused inorganic material (4) to obtain one stranded metal conductor.
17. The method according to item 15 or item 16, wherein the method comprises the step of
   introducing an elastomeric material (5) into voids (6) between the more than one metal wires (2) of the stranded metal conductor.
18. The method according to item 17, wherein the step of introducing the elastomeric material into the voids (6) of the stranded metal conductor is interrupted such that the stranded metal conductor comprises at least one segment (7) along the longitudinal direction of the power cable where the stranded metal conductor is provided with the elastomeric materials and at least one further segment along the longitudinal direction of the power cable where the stranded metal conductor is devoid of the elastomeric material.
19. The method according to any one of items 15 to 18, wherein the method further comprises one or more of the following steps:
surrounding the at least one metal wires (2) by an insulating layer (8);
   surrounding the insulating layer (8) by a semiconductor layer;
   providing an armouring layer.

### REFERENCE LIST

1 cable core
2 metal wire
3 section of the cable core
4 insulation material surrounding the metal wire, in particular enamel
5 elastomeric material
6 void
7 segment (of elastomeric material)
8 insulating material
9 further cable layers (not specified)
10 section of the cable core devoid of the material having the specified electrical conductivity
11 bend stiffener

1. A power cable for subsea applications,
the power cable comprising at least one cable core,
the cable core comprising a metal conductor,
the metal conductor comprising at least one metal wire,
wherein at least a section of the at least one metal wire along the longitudinal direction is surrounded with a material having an electrical conductivity of less than 1×10⁻⁸ S/m at 20°C.

2. The power cable according to claim 1, wherein the material having the electrical conductivity of less than 1×10⁻⁸ S/m at 20° C. is a fused inorganic material.

3. The power cable according to claim 2, wherein the fused inorganic material is an amorphous fused inorganic material.

4. The power cable according to claim 3, wherein the amorphous fused inorganic material is enamel.

5. The power cable according to claim 1, wherein the section has a length shorter than the complete length of the power cable.

6. The power cable according to claim 1, wherein the power cable is provided with a bend stiffener.

7. The power cable according to claim 6, wherein the power cable is provided with the bend stiffener at an end segment of the power cable or at a cable joint.

8. The power cable according to claim 6, wherein the bend stiffener has a position L along the longitudinal direction of the power cable, which L is also the length of the bend stiffener along the longitudinal direction of the power cable, wherein the section of the at least one metal wire being surrounded with the material is at least partly arranged at the position L.

9. The power cable according to claim 6, wherein the section of the at least one metal wire being surrounded with the material extends beyond the position along the longitudinal direction of the cable being provided with the bend stiffener.

10. The power cable according to claim 6, wherein a length of the section of the at least one metal wire being surrounded with the material, wherein the length is measured along the longitudinal direction of the power cable, exceeds the length L by a factor of 1.05 to 50, provided that the section of the at least one metal wire being surrounded with the material at least partially overlaps with the length L.

11. The power cable according to claim 1, wherein the metal conductor comprises more than one metal wire and each metal wire is surrounded by an elastomeric material in a segment.

12. The power cable according to claim 11, wherein the elastomeric material in the segment is solely attached to the surface of the metal wire, or wherein the segment of the elastomeric material at least partially overlaps in longitudinal direction of the power cable with the section of the at least one metal wire being surrounded with the material.

13. The power cable according to claim 1, wherein the metal conductor comprises more than one metal wire being devoid of distinguishable bundles of the more than one metal wire.

14. A method of manufacturing a power cable comprising the following steps:
providing at least one metal wire and a precursor of a fused inorganic material;
depositing the precursor of the fused inorganic material onto the at least one metal wire;
heating the precursor of the fused inorganic material to obtain the fused inorganic material on the at least one metal wire.

15. The method according to claim 14, wherein the method comprises the step of
arranging more than one of the at least one metal wire with the fused inorganic material to obtain one stranded metal conductor.

16. The method according to claim 14, wherein the method comprises the step of
introducing an elastomeric material into voids between the more than one metal wires of the stranded metal conductor.

17. The method according to claim 16, wherein the step of introducing the elastomeric material into the voids of the stranded metal conductor is interrupted such that the stranded metal conductor comprises at least one segment along the longitudinal direction of the power cable where the stranded metal conductor is provided with the elastomeric materials and at least one further segment along the longitudinal direction of the power cable where the stranded metal conductor is devoid of the elastomeric material.
